(19) United States
(12) Patent Application Publication
(10) Pub. No.: US 2005/0144062 A1
(43) Pub. Date: Jun. 30, 2005

(54) Business continuity information management system

(76) Inventors: Manish M. Mittal, New Delhi (IN); Vikas Goel, Jersey City, NJ (US)

Correspondence Address: Charles Rattner, 240 Wardwell St Apt 7, Stamford, CT, 06902-5254, US

(21) Appl. No.: 10/747,328

(22) Filed: Dec. 29, 2003

(51) Int. Cl. G06F 17/60

(52) U.S. Cl. 705/10

(57) ABSTRACT

A system is disclosed for implementing a corporate business continuity plan in which a plurality of governance rules are maintained and updated for one or more business locations. The governance rules establish business continuity responsibilities that are, in turn, assigned to designated employees for periodic or occasional action. Each designated employee is responsible for performing their assigned business continuity responsibilities and submitting statuses of such responsibilities to the system according to established timelines. One or more business continuity readiness indicators are then generated based on the submitted statuses.

### FIELD OF THE INVENTION

This invention generally relates to data processing for business practice management, and in particular it relates to allocating resources and scheduling for business continuity planning.

### BACKGROUND OF THE INVENTION

Temporary or long-term disruptions of a business office (due to power outage, communications failure, severe weather, natural disaster, terrorist attack and the like) can cause severe financial losses to a company. These losses will be needlessly multiplied unless sufficient contingency plans are properly executed that allow substantial continuation of the functions performed by any disrupted office.

Business continuity planning (BCP) is a risk management strategy that implements various functions to ensure the continuity of service delivery during any foreseen or unforeseen interruptions to one or more business offices. BCP issues have traditionally been addressed by manually or with little automation, verifying various readiness activities, without centralized reporting or individual accountability. Further, ease of information availability, availability and allocation of resources and prioritization of activities during any business disruption, and overall program costs, are key factors that organizations have to understand and effectively manage. As a corporation expands in size and its business processes evolve in complexity, it becomes necessary to more proactively ensure that business continuity plans are continuously addressed and maintained.

Previously, there have been insufficient technology solutions available for companies, and particularly, large corporations having multiple locations, to readily implement and sufficiently maintain an internal BCP program.

### SUMMARY OF THE INVENTION

It is an object of the present disclosure, therefore, to introduce various features of a business continuity information management system (BCIMS). In particular, a method for generating business continuity readiness indicators is introduced, in which a computerized system is used to transmit, to various designated business employees, a deadline for submitting a status of a business continuity responsibility applicable to one or more business offices. A readiness indicator is generated for each of the business continuity responsibilities, based on the statuses entered by the designated business employees. An overall readiness indicator for all business offices may also be generated, based on the readiness indicators submitted for the individual business continuity responsibilities.

The business continuity information management system maintains a plurality of governance rules for responding to an unplanned interruption of the business offices. The governance rules may include any of the following: a schedule for conducting business continuity testing; a schedule for performing a backup of data maintained at each business office, a requirement to maintain an updated list of employees at each business office; a requirement to maintain communications to be distributed to employees, vendors and customers upon an interruption of a business office; and an evacuation plan for each business office.

Individual business continuity responsibilities may include: conducting a business continuity test, updating employee information, updating the various communications to be distributed in the event of a business interruption, and performing periodic backup of data maintained by a business office. BCIMS may include automation of the performance of certain of these responsibilities, such as the performance of data backups and verification thereof.

The readiness indicators may be reported as a percentage of business continuity responsibilities for which a positive status has been received, and may be color-coded with a first color for representing a satisfactory status and a second color for representing an unsatisfactory status.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a schematic diagram of an exemplary computer network environment in which the present disclosure may be practiced;

FIG. 2 is a flowchart depicting an exemplary business continuity method performed by a server within the network of FIG. 1;

FIG. 3 is a depiction of an exemplary user interface for presenting contents of a business continuity document library maintained by the server of FIG. 1;

FIG. 4 is a depiction of an exemplary user interface for presenting an employee contact list maintained by the server of FIG. 1;

FIG. 5 is a depiction of an exemplary user interface for presenting BCP plans maintained by the server of FIG. 1;

FIG. 6 is a depiction of an exemplary user interface for presenting BCP metrics maintained by the server of FIG. 1; and

FIG. 7 is a depiction of an exemplary user interface for presenting overall indicators by general BCP category as maintained by the server of FIG. 1.

### DETAILED DESCRIPTION OF THE SPECIFIC EMBODIMENTS

BCIMS is a management tool that provides risk readiness indicators for various business continuity responsibilities and provides current information that enables instantaneous monitoring and periodic reporting of a company's overall state of BCP readiness. BCIMS includes one or more database repositories of business information, a programmed tool to capture and report information, and an associated governance model where critical information is requested and received directly from an assigned employee or a group of employees. That is, the system captures relevant BCP information various employees across one or more business locations within a corporation. The submitted BCP information is then used to provide a status indicator for each of the various business continuity responsibilities established by the governance rules, as well as overall indicators for one or more categories of such responsibilities. The status information can be used by employees to instantly assess the state of readiness of people, processes, technology and infrastructure at any location, to quickly identify any problem areas and to take proactive steps to strengthen the readiness level in those areas.

BCIMS not only ensures the safety and security of employees and corporate assets in the event of a workplace disruption, but also ensures that business critical services are restored within predefined recovery standards and with minimized impact on customer service levels and the like. It ensures a constant state of readiness by defining key business continuity responsibilities, assigning accountability for the completion of those responsibilities, and escalating the responsibility to a higher-ranked employee in the event of deviation or failure to timely complete the activity.

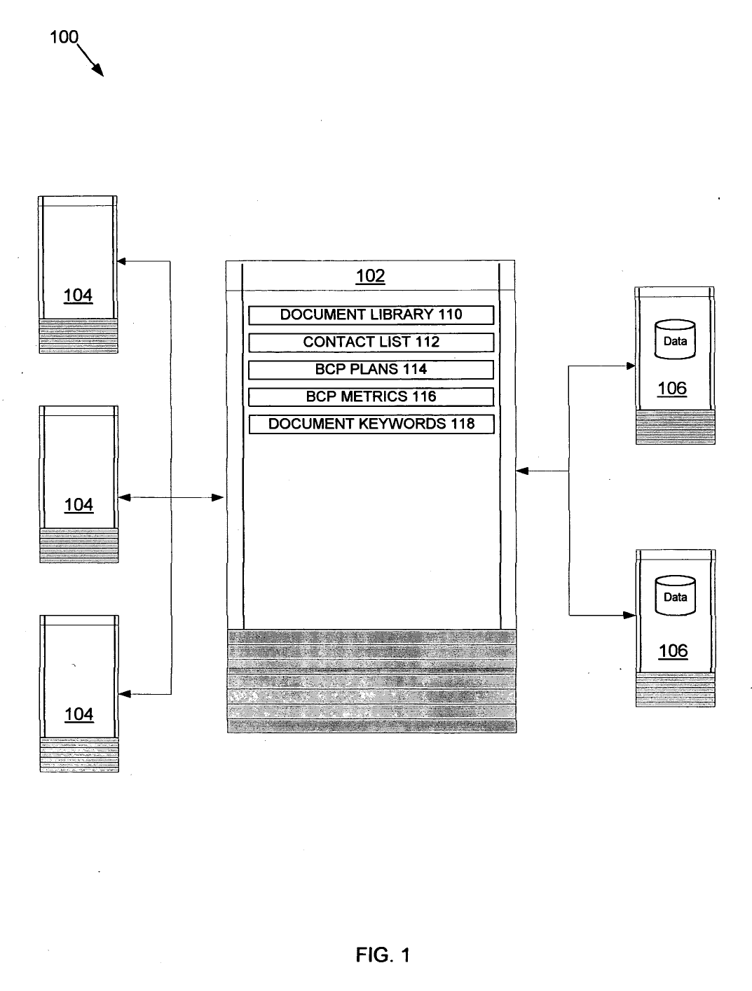

With reference now to FIGS. 1-7, wherein similar components of the present disclosure are referenced in like manner, various embodiments of the business continuity information management system will now be described.

Turning to FIG. 1, there is depicted an exemplary network 100 on which BCIMS may be implemented. The network 100 may include a BCIMS server 102, a plurality of user terminals 104, and one or more backup servers 106. It is readily contemplated that the network 100 may be any type of network over which computer data and instructions may be transmitted, including but not limited to a local area network (LAN), a wide area network, a corporate intranet, a fiber optic network, a wireless network, the Internet, or any combination or interconnection of the same. The network 100 is also not necessarily restricted to the number of components, or their manner of interconnection, as shown in FIG. 1.

As described herein, the BCIMS server 102, the plurality of user terminals 104, and the backup servers 106 are described as being operated by one organization, such as a corporation with one or more business offices. However, any one or more of these components of the network 100 may be operated and maintained by a trusted third party in appropriate situations. In the case of a multi-location corporation, it is contemplated that its various business offices may each maintain one or more of the components of the network 100, and that the various business offices may be in geographically-disperse locations (i.e. off-site”), or even separate countries (i.e., “off-shore”). In such case, the network 100 may include various effective and well-known security measures, such as encryption and secure transmission protocols, to securely communicate data among the various components of the network 100.

The BCIMS server 102 operates to store a plurality of databases and programming instructions, the execution of which, in conjunction with appropriate storage and retrieval of data from the stored databases, enables the performance of the various BCP functions described herein. The BCIMS server 102 may accordingly be any type of computing device, including, for example, an enterprise network server of the type commonly manufactured by IBM CORPORATION. The BCIMS server 102 may also be a group of distributed servers rather than a single server as shown in FIG. 1.

The user terminals 104 may be any type of computing device that can communicate with the BCIMS server 102 over the network 100 in order to accomplish the functions described herein. Accordingly, the user terminals 104 may each be a personal computer, or the like, operated by a designated employee having one or more assigned BCP responsibilities. In an embodiment where BCIMS is implemented by a multi-location business organization, each user terminal 104 shown in FIG. 1 may instead be representative of a LAN having one or more local servers and user terminals located within a particular business office.

The backup servers 106 of FIG. 1 are operative to receive and maintain any backups of critical business data maintained by the one or more business offices of an organization, including backups of data maintained by the BCIMS server 102. In the case of a multi-location financial services corporation, such critical business data may include financial account records, statutory and regulatory activities, and account receivable/payable information from various business offices. Accordingly, the backup servers 106 may be any type of computing devise, such as an enterprise backup server, or a group of distributed servers, with sufficient storage capacity for performing and maintaining such data backups.

The various components of the network 100 may be operated by or under the responsibility of various designated business employees having BCP-related responsibilities. It is contemplated that an organization implementing BCIMS may arrange a hierarchy of such personnel so that BCP responsibilities are properly assigned, conducted and reviewed. In one possible embodiment involving a multi-location organization, designated business personnel may include: (i) a BCP administrator responsible for overall coordination with respect to monitoring, reporting, compliance, readiness and periodic functional reviews of BCP activities at all business offices; (ii) an area administrator at each business office responsible for the coordination of BCP activities as assigned to their location; and (iii) an area team having various employees responsible for developing, planning, testing, executing, implementing, reporting and reviewing one or more BCP responsibilities assigned to them based on their position within the organization. Each area team member is responsible and accountable for the compliance of the BCP activities and tasks assigned to their location, and each member acts as a single point of contact for any activity directly or indirectly assigned to them. The area team may include various corporate personnel, such as: process coordinators, human resource supervisors, managers, secretaries, and technology, facility and communication coordinators.

For purposes of securing BCMIS, and to prevent unapproved changes to BCP policy, each employee having BCP responsibilities may each be granted a level of access to BCIMS appropriate to their position or title within an organization. A read-only level is the lowest, or most restricted level of access, and may be generally granted to low-ranking employees. Read only access will enable an employee to browse BCP information, but does not allow such employee to edit or revise any BCP information. However, for certain limited purposes, read-only access may allow an employee to add to the stored BCP information.

An intermediate level of access may be granted to area coordinators and other appropriate personnel, which allows a user to browse all stored information, as well as to revise and edit certain levels of stored BCP information. A highest level of access may be assigned to BCP administrators and other top-ranking employees, which allows unrestricted access and revision to all levels of BCP information stored in the BCIMS system.

Returning to FIG. 1, the BCIMS server 102 may act as a central data repository for all BCP-related information. The stored information and associated processes may be maintained and implemented by any suitable enterprise organizational software, such as LOTUS NOTES, that allows centralization of critical business information and organization of such content for efficient retrieval. BCP-related information may include business employees and contacts, BCP procedures, communication protocols, recovery requirements and other decision-making processes that are needed in order to properly respond to a disruptive event or incident.

Accordingly, the BCIMS server 102 may store and maintain the following: a document library 110 for storing BCP guidelines and instructions (that contain various types of BCP information, such as testing reports, templates, policy information, training documents, and the like); a contact list 112 for storing employee, vendor and customer contact information; a collection of BCP plans 114 including processing instructions for implementing BCP responsibilities and responding to interruptions of a business office; a collection of BCP metrics 116 including readiness reports for the various BCP responsibilities; and a collection of document keywords 118, which may include searchable metadata, master search terms, or the like, describing various of the stored BCP documents.

In certain embodiments, the BCIMS server 102 may maintain, within the document library 110, a plurality of textual governance rules for responding to an unplanned interruption of the business offices. The governance rules may include any of the following: schedules for conducting business continuity testing; schedules for performing backups of data maintained at each business office; requirements for updating lists of employees and contacts for each business office; requirements to maintain communications to be distributed to employees, vendors and customers upon an interruption of a business office; and evacuation plans for each business office. The governance rules may also include assignments of various BCP-related responsibilities to designated personnel. Corresponding processing instructions may be implemented that enable the BCIMS server 102 to properly identify such designated personnel and receive statuses of their assigned responsibilities in accordance with the governance rules.

The document library 110 may also store textual crisis management guidelines and instructions that are required to be implemented in response to an interruption of a business office. Such guidelines provide a detailed list of steps for designated business employees to follow upon an interruption of a business office.

The document library 110 may additionally store communications notes to be circulated among employees, customers, government and other regulatory authorities, vendors, upon an imminent or actual interruption of a business office. Such contents may be required to be periodically reviewed and updated by designated employees according to the governance rules.

The document library 110 may also include other categories of important or relevant information that cannot be categorized under any of foregoing descriptions.

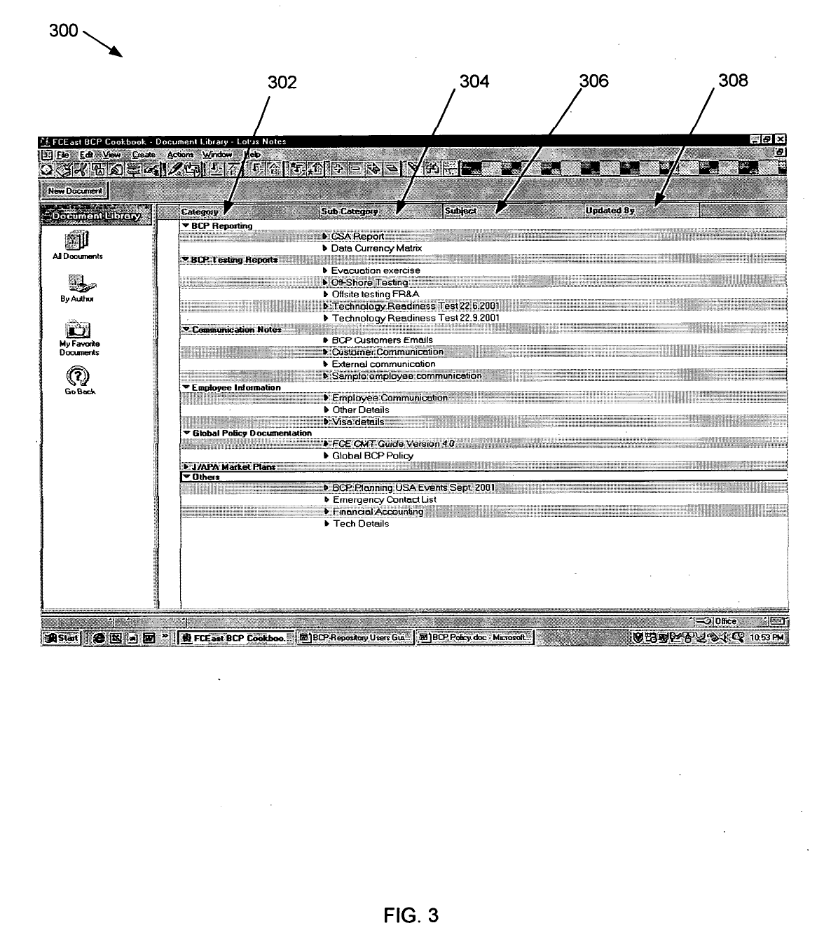

The document library 110 may be organized such that stored documents have assigned category, subcategory, and subject matter descriptions, as well as update information corresponding to a revision of a particular document. Such stored documents may be presented to BCP personnel on a remote terminal 104 within a document library window 300, as shown in FIG. 3. The window 300 may include appropriate category fields 302, subcategory fields 304, subject fields 306, and revision information fields 308 to present such stored document information.

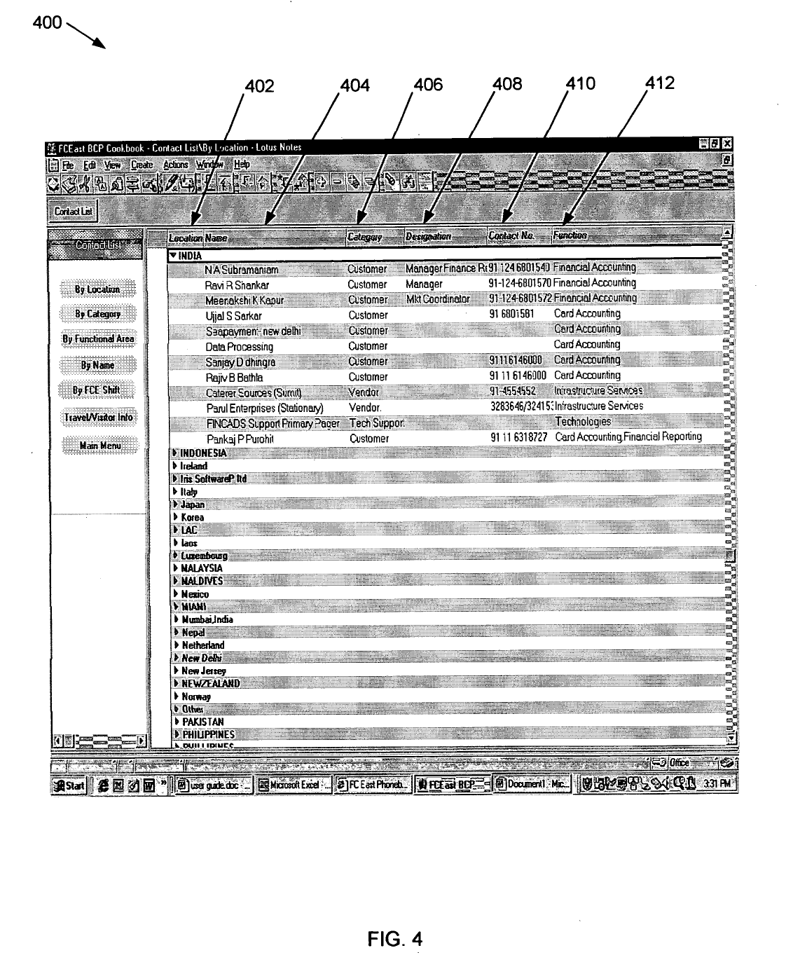

With reference once again to FIG. 1, the BCIMS server 102 may also store a continuously updated contact list 112 of employees, vendors, customers and other appropriate parties. A contact list may include, for example, a location, name, category (i.e., employee, customer, or vendor), title, personal contact information, and a description of the contact's function with respect to the organization. Such contact lists may be presented to BCP personnel on a remote terminal 104 within a contact list window 400, as shown in FIG. 4. The window 400 may include appropriate location fields 402, name fields 404, category fields 406, description fields 408, contact information fields 410 and function fields 412 for displaying such contact information. Employee contact information may also include particular information on visiting or non-temporary employees, including scheduled times for visitation, and (in the case of foreign employees) visa details and emergency contact numbers. All contact lists may be required to be periodically updated and confirmed according to the governance rules.

The BCIMS server 102 may additionally store and execute processing instructions for implementing various BCP plans 114. These processing instructions may include directions for notifying designated employees to update the status of their assigned BCP responsibilities, as well as processing instructions for storing any received statuses and reporting the status of all BCP related activities. Individual BCP responsibilities may include: conducting business continuity tests as directed by governance rules, updating employee information and other contact lists, updating the various communication notes to be distributed in the event of a business interruption, and performing periodic backup of data maintained by a business office. The BCIMS server 102 may be programmed to automatically perform certain of these responsibilities itself, such as initiating data backups for all business offices and verifying that such backups have been properly completed.

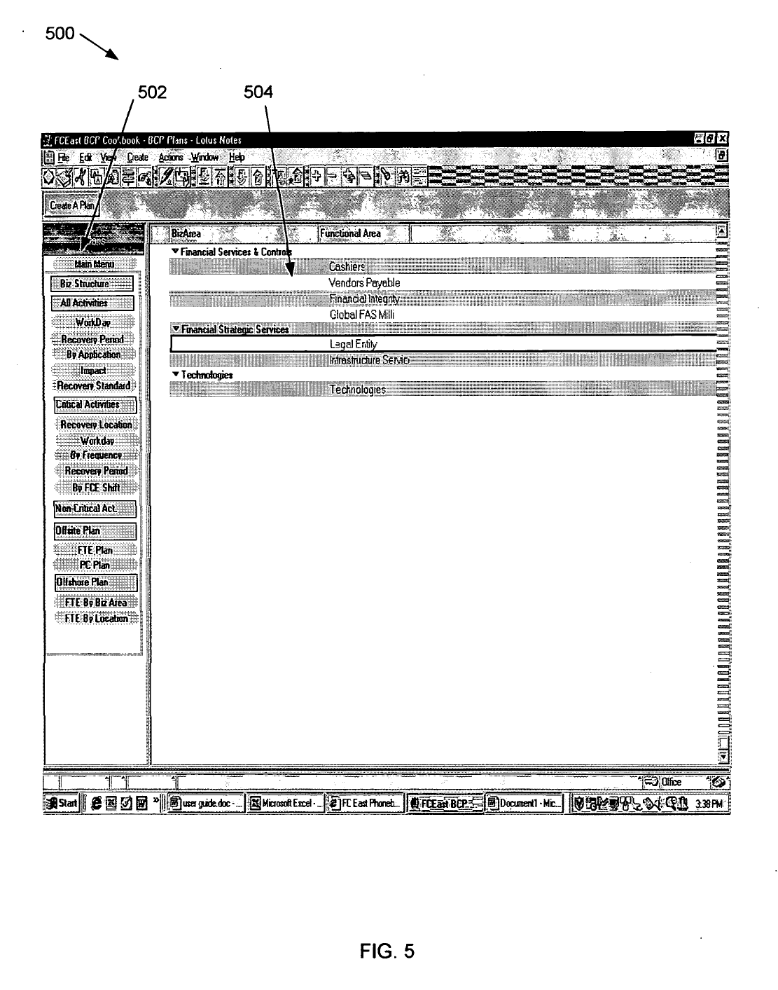

Each BCP activity/responsibility may be presented to BCP personnel in an exemplary BCP activity window 500, such as that shown in FIG. 5. The activity window 500 may include a menu 502 for accessing various categories of BCP plans and an activity display pane 504 for displaying information on any BCP plans selected from the menu 502. BCP plans may include selectable functions for retrieving: a company's business structure; BCP responsibilities/activities, critical activities, non-critical activities, off-site plans, and off-shore plans. Additional or alternate functions may readily be provided within the menu 502.

Returning again to FIG. 1, the BCIMS server 102 may store various processing instructions for generating and presenting various BCP-related reports, referred to herein as BCP metrics 116. Such metrics 116 may present readiness indicators for the various BCP responsibilities based on individual BCP activity statuses received from designated business employees. The reports may be segregated based on categories of such responsibilities or may be generated by business location. The reports described herein may be generated automatically and periodically, or may be generated upon request from any BCP personnel.

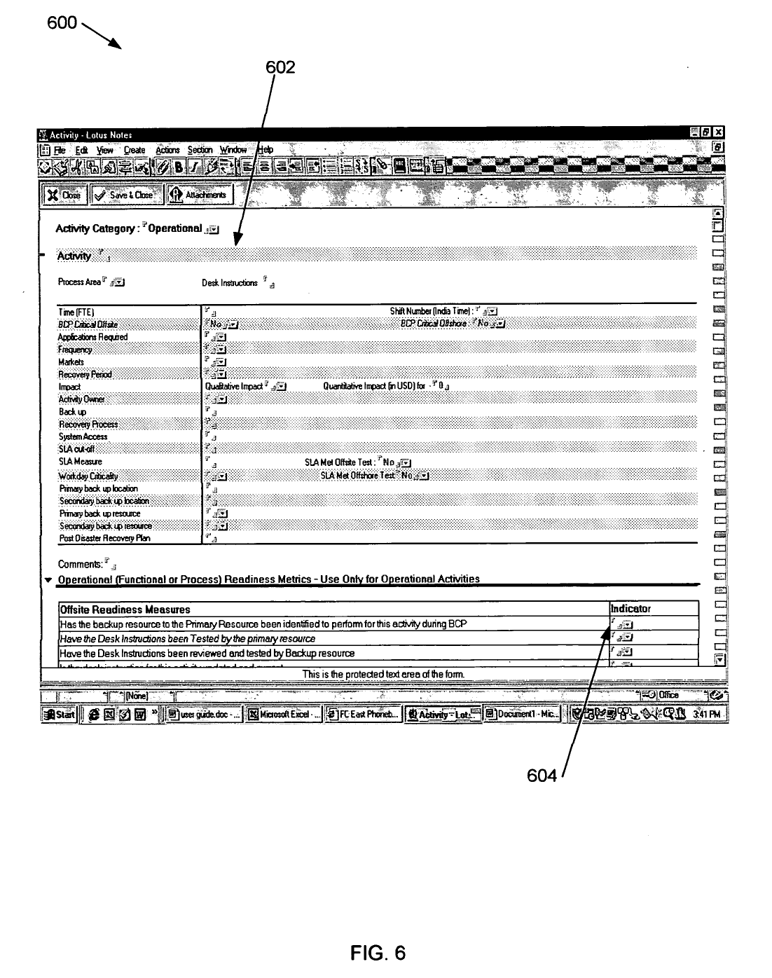

An exemplary reporting window 600 for presenting BCP metrics is shown in FIG. 6. The window 600 may include a display pane 602 for displaying one or more BCP activities or category of activities and displaying the current readiness indicators 604 associated therewith.

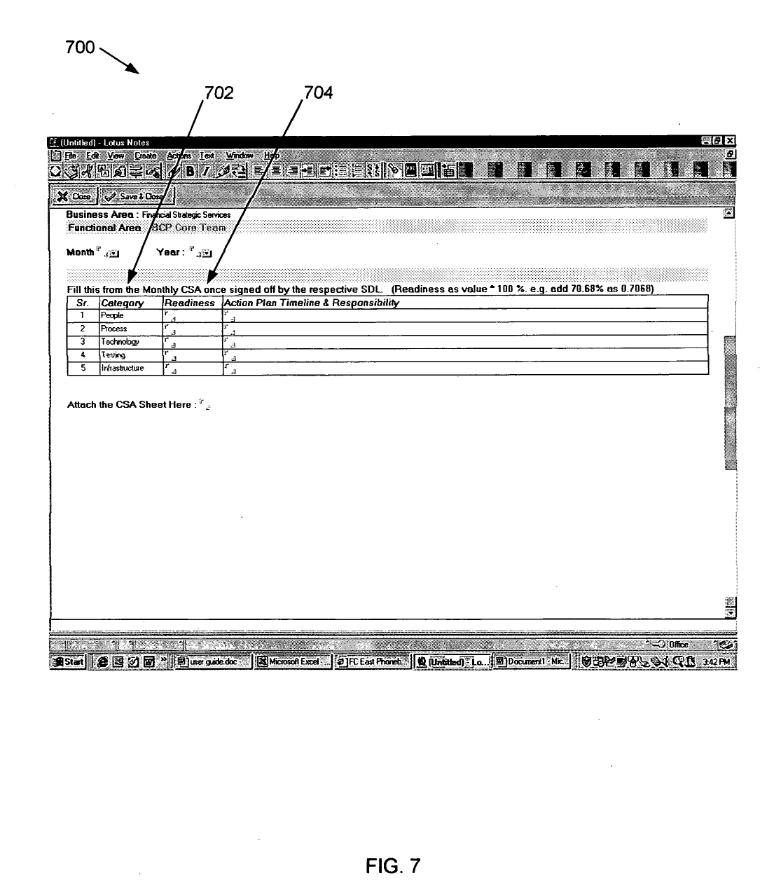

The governance rules may dictate that specific reports be generated on a predetermined, periodic basis. One exemplary report may include a control self-assessment (CSA) report, the objective of which is to present readiness indicators on various general BCP categories, such as personnel, processes, technology and infrastructure. An exemplary CSA report window 700 is shown in FIG. 7. The window 700 may include a category of activity field 702 and various overall readiness indicators 704 for each category, which are generated from the statuses of individual BCP activities within each category. CSA reports may be automatically generated on a monthly basis, or as otherwise may be required.

Another exemplary report may be a data currency matrix that contains indicators on the current state of BCP preparation, such as compliance with data backup schedules. Data currency matrices may be automatically generated on a weekly basis, or as otherwise may be required.

A BCP testing report may also likewise be periodically generated. Various BCP testing reports may relate to off-site or offshore testing of critical process or applications, or evacuation drills performed at the various business offices of an organization. The objective of these testing reports is to identify any gaps in BCP implementation so that corrective measures may be taken.

An issue log database may also be provided to enter miscellaneous BCP related issues and dates by which such issues are to be resolved. Reports from the issue log database may be generated on a periodic or on-demand basis.

The BCIMS server 102 of FIG. 1 may also maintain document keywords 118 or metadata that describe the various documents and reports maintained therein. Such metadata enables rapid search and selection of information desired by BCP personnel. This information, in certain embodiments, may only be revised by those with the least restrictive level of access to the BCIMS server 102.

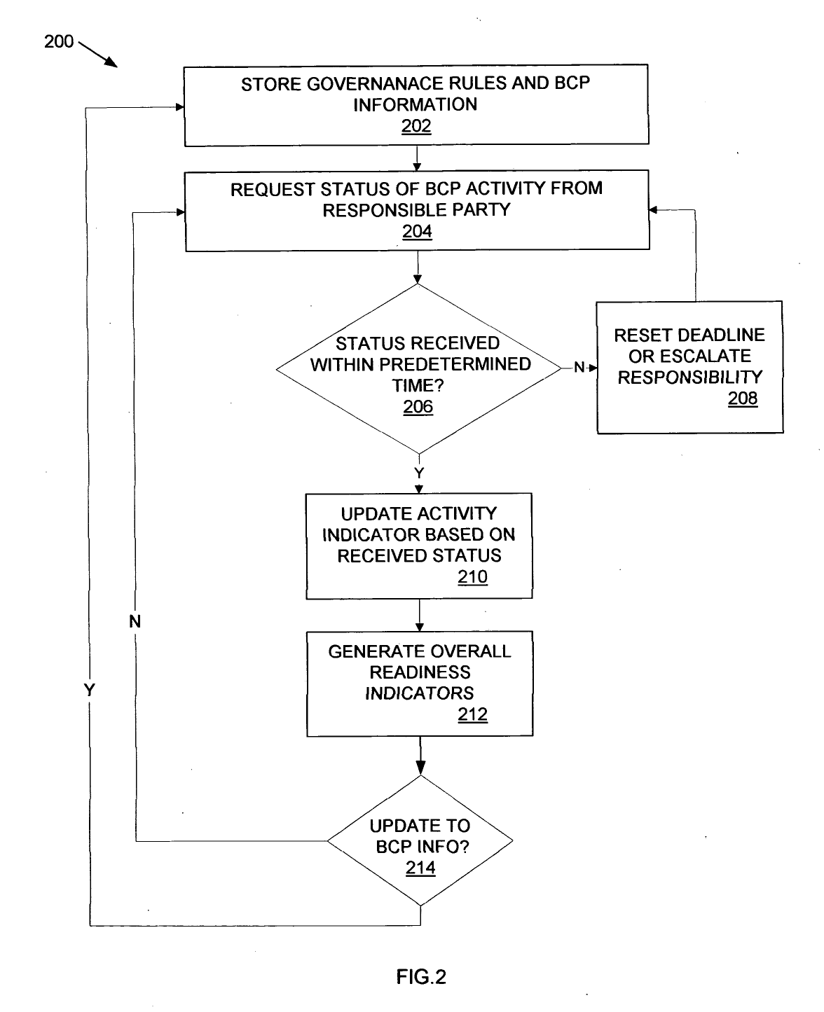

Turning now to FIG. 2, therein is depicted an exemplary process 200 performed by BCIMS for generating BCP related readiness indicators. The process 200 commences with the storage of governance rules and related BCP information (step 202), that were described in the foregoing with respect to FIGS. 3-5.

Upon reaching a deadline for submitting the status of a particular BCP activity, the BCIMS server 102 may transmit a request for a status of such BCP activity from the designated employee or employees responsible for the activity (step 204). The request may be transmitted by the BCIMS server 102 to the responsible employee's user terminal 104 via electronic mail message, instant message, or the like. Reminders of approaching deadlines may additionally be transmitted in advance of a final deadline for the requested status.

Next, at step 206, the BCIMS server 102 determines whether the requested status has been received by the predetermined deadline. If not, the process 200 continues to step 208 immediately below, otherwise the process 200 continues to step 210 described later below.

At step 208, when a requested status is not submitted or remains unanswered by its predetermined deadline, the BCIMS server 102 may reset the deadline to a time in the near future (i.e. in one business day) and transmit a request for the status to be submitted by the new deadline. However, if the BCP activity is critical, or if the status has repeatedly not been completed after one or more reset deadlines, the responsibility for the activity may instead be automatically escalated to a higher-level BCP employee, such as the designated employee's supervisor. If the activity's status is not submitted after a first escalation, the responsibility may be escalated to successively higher employees in the BCP hierarchy until the BCP activity is completed and an acceptable status is submitted. This escalation of a BCP responsibility may be performed automatically by the BCIMS server 102 in accordance with the stored governance rules and associated processing instructions.

If, at step 206, the requested status of a BCP activity is indeed submitted by the deadline, the BCIMS server 102 then updates one or more activity readiness indicators 604 associated with the activity according to the received status (step 210). The received status may be a simple “yes” or “no” response or the like to indicate whether the activity has been completed. The readiness indicator may be “100%” indication for a completed activity or “0%” for an uncompleted activity. The activity readiness indicator may also be color coded (i.e. the color green for a completed activity and the color red for an uncompleted activity) so that employees may readily identify those activities with unsatisfactory statuses from a list of activities reported by the BCIMS server 102.

Next, at step 212, the BCIMS server may generate one or more overall readiness indicators 212, representing an organization's overall BCP readiness (step 212), based on the individual activity status received in step 210. One overall indicator 704 may be provided for each category of BCP activity, such as the categories “personnel,” processes,” “technology,” “testing,” and “infrastructure” described previously with respect to FIG. 7. The overall percentage of readiness for a category may correspond directly to the number of BCP activities within the category that have completed statuses. Overall indicators 704 may also be color-coded in a similar manner to that previously described with respect to the individual readiness indicators 604.

From step 212, the process 200 continues to step 214 where the BCIMS server 102 determines whether there are updates received for stored BCP instructions. If so, the process 200 returns to step 202 where such updated instructions are stored. Otherwise, the process 200 returns to step 204 where the BCIMS server 102 requests a status for the next activity due. The process 200 is conducted continuously in this manner in order to ensure that an organization is continuously prepared in the event of a disruption to its operation.

In accordance with the process 200, described above, the BCIMS will now be described in one brief example: A secretary is located in one office of a multi-location corporation that operates BCIMS. She is assigned responsibility for a particular BCP-related activity, namely, periodically updating the list of employees at her location. A periodically-recurring deadline is assigned to this activity by the governance rules and tracked by the BCIMS server 102. As the deadline approaches, one or more reminders may be sent by the BCIMS server 102 to the secretary's user terminal 104 to remind her of the deadline for updating the employee list. As the deadline arrives, the BCIMS server 102 requests the status (if it has not already been submitted) and confirms whether the secretary has submitted the status “completed” for this activity. If a “completed” status is not submitted, or if the secretary fails to respond to the request altogether, the deadline may be reset by the BCIMS server 102 and the readiness indicator for the activity is set to 0%. A readiness indicator for the general BCP category “people” (which includes this assigned activity as well as other BCP activities corresponding to the business' personnel) may be decreased, based on the 0% status entered for this activity. If the deadline is critical or if successive deadlines for this activity have not been met by the secretary, the responsibility for the activity may be escalated to the secretary's supervisor, who is then notified of the new deadline for completing the activity by the BCIMS server 102. Upon submission of a “completed” status, the readiness indicator for this activity is changed to 100%, which may, in turn increase the readiness indicator for the general BCP category “people.”

In the manners described in the foregoing, BCIMS ensures that the impact of any crisis event is minimized or negated for shareholders, customers, vendors and employees of a business organization. It also mitigates the operational risk of migrating business activities to new locations since recovery standards are identified and constantly maintained.

Although the best methodologies of the invention have been particularly described in the foregoing disclosure, it is to be understood that such descriptions have been provided for purposes of illustration only, and that other variations both in form and in detail can be made thereupon by those skilled in the art without departing from the spirit and scope of the present invention, which is defined first and foremost by the appended claims.

1. A method for determining a readiness for implementing a business continuity plan, comprising:
storing an assignment of at least one business continuity responsibility for each of a plurality of designated business employees;
periodically requesting, from each of the designated business employees, a status of the at least one business continuity responsibility assigned thereto;
receiving a requested status from at least one of the designated business employees; and
generating a business continuity readiness indicator based on the received status.

2. The method of claim 1, further comprising storing a plurality of governance rules including at least one of a schedule for conducting business continuity testing; a schedule for performing a backup of data maintained at the at least one business office; a requirement to maintain an updated list of employees at the at least one business office; a requirement to maintain communications to be distributed to employees, vendors and customers upon an interruption of the at least one business office; and an evacuation plan for the at least one business office.

3. The method of claim 1, said business continuity responsibility comprising at least one of:
conducting a business continuity test, updating employee information, updating the communications to be distributed, and performing the backup of data.

4. The method of claim 1, wherein each designated business employee is assigned a distinct business continuity responsibility for a business office.

5. The method of claim 1, further comprising:
identifying an unanswered requested status; and
transmitting a reminder to the designated business employee to update the unanswered requested status.

6. The method of claim 5, further comprising:
establishing a deadline for responding to the reminder.

7. The method of claim 5, further comprising:
transmitting a notification to a second, higher-ranked business employee if the unanswered status request is not acted upon by the designated business employee.

8. The method of claim 1, wherein the requested status of the at least one business continuity responsibility includes a deadline for submitting the status.

9. The method of claim 1, said generating further comprising:
generating a readiness indicator for each business continuity responsibility and an overall readiness indicator of compliance with the governance rules.

10. The method of claim 1, the business continuity readiness indicator comprising a first color for representing a satisfactory status and a second color for representing an unsatisfactory status.

11. The method of claim 1, said business continuity readiness indicator comprising a percentage corresponding to a number of assigned business continuity responsibilities for which a positive status has been received.

12. A method for generating a business continuity readiness indicator, comprising:
transmitting, to a designated business employee, a deadline for submitting a status of a business continuity responsibility within a business office;
generating a readiness indicator for the business continuity responsibility based on the status entered by the designated business employee; and
generating a readiness indicator for the business office based on the readiness indicator for the business continuity responsibility.

13. The method of claim 12, said transmitting further comprising:
transmitting, to a second business employee, a deadline for submitting a status of a second business continuity responsibility for the business office;
generating a second readiness indicator for the second business continuity responsibility; and
generating the readiness indicator for the business office based on the readiness indicator for the business continuity responsibility and the second readiness indicator for the second business continuity responsibility.

14. The method of claim 12, said transmitting further comprising:
transmitting, to a second business employee, a deadline for submitting a status of a second business continuity responsibility for a second business office;
generating a second readiness indicator for the second business continuity responsibility; and
generating the readiness indicator for all business offices based on the readiness indicator for the business continuity responsibility and the second readiness indicator for the second business continuity responsibility.

15. The method of claim 12, further comprising:
storing a plurality of governance rules for responding to an unplanned interruption of the business office, the governance rules comprising at least one of a schedule for conducting business continuity testing; a schedule for performing a backup of data maintained at the business office; a requirement to maintain an updated list of employees at the business office; a requirement to maintain communications to be distributed to employees, vendors and customers upon an interruption of the business office; and an evacuation plan for the business office.

16. The method of claim 12, said business continuity responsibility comprising at least one of:
conducting a business continuity test, updating employee information, updating the communications to be distributed, and performing the backup of data.

17. The method of claim 12, the readiness indicator for the business continuity responsibility comprising a first color for representing a satisfactory status and a second color for representing an unsatisfactory status.

18. The method of claim 12, said readiness indicator for the business office comprising a percentage corresponding to a number of business continuity responsibilities for which a positive status has been received.

19. A method for indicating a readiness of a business continuity plan, comprising:
storing a plurality of governance rules for responding to an unplanned interruption of at least one business office, the governance rules assigning at least one business continuity responsibility to each of a plurality of designated business employees;
periodically requesting, from each of the designated business employees, a status of the at least one assigned business continuity responsibility;
generating a readiness indicator for each business continuity responsibility based on the statuses entered by the designated business employees; and
generating a readiness indicator for the at least one business office based on the readiness indicators for each of the business continuity responsibilities.
